(19) United States
(12) Patent Application Publication
(10) Pub. No.: US 2007/0152595 A1
(43) Pub. Date: Jul. 5, 2007

(54) Plasma display panel

(76) Inventor: Ho-Seok Lee, Suwon-si (KR)

Correspondence Address: CHRISTIE, PARKER & HALE, LLP, PO BOX 7068, PASADENA, CA, 91109-7068, US

(21) Appl. No.: 11/645,925

(22) Filed: Dec. 26, 2006

(30) Foreign Application Priority Data
Dec. 30, 2005 (KR) 10-2005-0135855

(51) Int. Cl. H01J 17/02

(52) U.S. Cl. 313/610

(57) ABSTRACT

A plasma display panel is provided. The plasma display panel includes a first substrate, a second substrate facing the first substrate, and a pair of discharge electrodes disposed between the first substrate and the second substrate. The pair of discharge electrodes include a first discharge electrode having a plurality of first discharge sub-electrodes, and a second discharge electrode facing the first discharge electrode and having a plurality of second discharge sub-electrodes. Widths of the first discharge electrode and the second discharge electrode in a non-display area are greater than or equal to widths of the first discharge electrode and the second discharge electrode in a display area.

### CROSS-REFERENCE TO RELATED PATENT APPLICATION

This application claims priority to and the benefit of Korean Patent Application No. 10-2005-0135855, filed on Dec. 30, 2005, in the Korean Intellectual Property Office, the entire content of which is incorporated herein by reference.

### BACKGROUND OF THE INVENTION

1. Field of the Invention

The present invention relates to a plasma display panel, and more particularly, to a plasma display panel having a structure that can minimize shortage of discharge electrodes.

2. Description of the related art

Conventionally, a plasma display panel is a flat display device that displays desired numbers, letters, or graphics by exciting a phosphor material in a phosphor layer using ultraviolet rays generated by discharge of a discharge gas filled between two substrates on which a plurality of electrodes are formed.

A conventional three-electrode surface discharge type plasma display panel includes a first substrate and a second substrate. Sustain discharge electrode pairs that include a first discharge electrode and a second discharge electrode, a first dielectric layer that buries the first and second discharge electrodes, and a passivation film layer that covers the first dielectric layer are formed on an inner surface of the first substrate. A plurality of address electrodes crossing the sustain discharge electrode pairs and a second dielectric layer that buries the address electrodes are formed on an inner surface of the second substrate. Barrier ribs that define discharge cells are formed between the first substrate and the second substrate, and red, green, and blue color phosphor layers are coated on inner walls of the barrier ribs.

The first discharge electrode consists of a first transparent electrode and a first bus electrode that overlaps with the first transparent electrode along an edge of the first transparent electrode. The second discharge electrode consists of a second transparent electrode and a second bus electrode that overlaps with the second transparent electrode along an edge of the second transparent electrode.

In the conventional plasma display panel having the above structure, the discharge cells located at intersections of the second discharge electrode and the address electrodes are selected by respectively applying electrical signals to the second discharge electrode and the address electrodes. Afterwards, a surface discharge is generated from a surface of the first substrate by alternately applying an electrical signal to the first and second discharge electrodes in order to generate ultraviolet rays. Visible light is emitted from the red, green, and blue color phosphor layers coated in the selected discharge cells. Therefore, the plasma display panel can display a stationary image or a moving image.

In the conventional plasma display panel, the first transparent electrode and the second transparent electrode are formed of a transparent conductive film in order to avoid blocking of the propagation of the visible light emitted from the phosphor layers towards the first substrate.

However, the transparent conductive film generally has high resistance, a large voltage drop in a lengthwise direction resulting in a high driving power consumption, and a long response time.

Therefore, the first bus electrode and the second bus electrode which are formed of an opaque metal having high electrical conductivity are respectively formed along edges of the first transparent electrode and the second transparent electrode.

In this way, in the prior art, the plurality of transparent electrodes and bus electrodes must be separately formed on the first substrate. Therefore, manufacturing costs increase due to the relatively expensive transparent electrodes, complicated manufacturing process, and increased manufacturing time.

Therefore, recently, electrode structures in which only the bus electrode is patterned on a substrate without the transparent electrode have been studied.

However, when only the bus electrode is formed, if the width of the bus electrode is excessively wide, the bus electrode reduces an opening ratio of the plasma display panel, and thus, brightness is reduced and power consumption is unnecessarily increased. However, if the width of the bus electrode is excessively narrow, discharge is not smoothly generated.

A plasma display panel includes a display area on which images are displayed and a non-display area which is disposed on edges of the display area and is a portion for electrically connecting with external terminals. When the bus electrode is disposed to extend from the display area to the non-display area, fissures occur at the portion for connecting with external terminals during firing. When the end portion of the bus electrode fissures, the fissured fragment can cause a short circuit between adjacent bus electrodes.

### SUMMARY OF THE INVENTION

In accordance with the present invention a plasma display panel is provided in which optimum design of discharge electrodes is possible by controlling cross-sectional areas of each of the discharge electrodes.

According to an aspect of the present invention, a plasma display panel is provided having a first substrate, a second substrate facing the first substrate, and a pair of discharge electrodes disposed between the first and second substrates. The pair of discharge electrodes include a first discharge electrode having a plurality of first discharge sub-electrodes and a second discharge electrode facing the first discharge electrode and having a plurality of second discharge sub-electrodes. Widths of the first discharge electrode and the second discharge electrode in a non-display area are greater than or equal to widths of the first discharge electrode and the second discharge electrode in a display area.

The plurality of first discharge sub-electrodes may be electrically connected to each other, the plurality of second discharge sub-electrodes may be electrically connected to each other, and the plurality of first and second discharge sub-electrodes extend in the same direction.

The plurality of first discharge sub-electrodes may include at least two first discharge sub-electrodes parallel to each other, the at least two first discharge sub-electrodes being connected by first bridge electrodes disposed therebetween, and the plurality of second discharge sub-electrodes may include at least two second discharge sub-electrodes parallel to each other, the at least two second discharge sub-electrodes being connected by second bridge electrodes disposed therebetween.

A first terminal bridge electrode may be formed by connecting the end portions of the plurality of first discharge sub-electrodes, and a second terminal bridge electrode may be formed by connecting the end portions of the plurality of second discharge sub-electrodes.

The widths of the first and second terminal bridge electrodes may be greater than or equal to the widths of the plurality of first and second sub-electrodes disposed in a display area.

A first terminal electrode may protrude from the first terminal bridge electrode in the same direction as the plurality of first discharge sub-electrodes, and a second terminal electrode may protrude from the second terminal bridge electrode in the same direction as the plurality of second discharge sub-electrodes.

The widths of the first and second terminal electrodes may be greater than or equal to the widths of the plurality of first and second sub-electrodes disposed in a display area.

Portions of the first terminal bridge electrode and the second terminal bridge electrode facing each other may be rounded.

The discharge electrodes may be formed without indium tin oxide, and therefore be formed of a metal having a high conductivity.

### BRIEF DESCRIPTION OF THE DRAWINGS

FIG. 1 is a partial cutaway exploded perspective view illustrating a plasma display panel according to an embodiment of the present invention.

FIG. 2 is a cross-sectional view taken along a line I-I according to an embodiment of the present invention of FIG. 1.

FIG. 3 is a section view illustrating the plasma display panel according to an embodiment of the present invention of FIG. 1.

### DETAILED DESCRIPTION

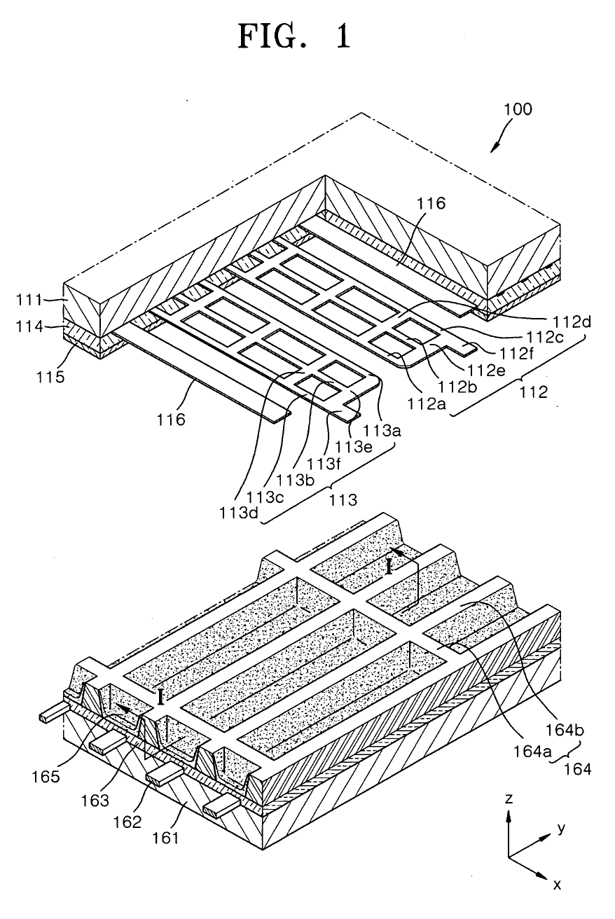

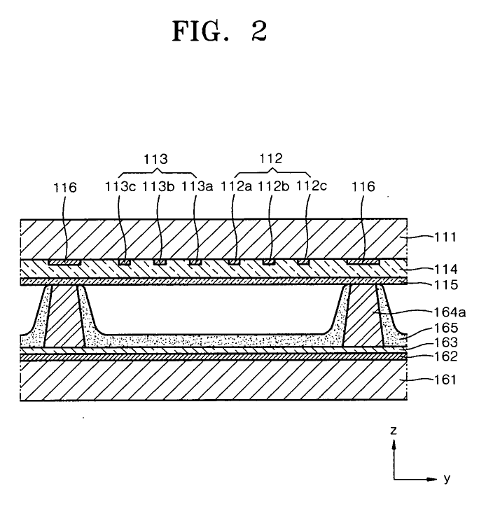

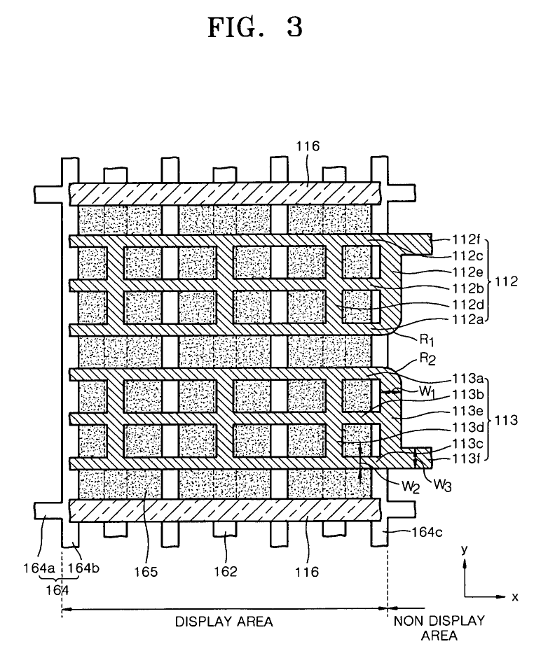

Referring to FIGS. 1 through 3, the plasma display panel 100 includes a first substrate 111 and a second substrate 161 facing the first substrate 111. A sealant (not shown) such as frit glass is coated along edges of surfaces of the first and second substrates 111, 161 facing each other, and the first and second substrates 111, 161 are thermally bonded to seal a space therebetween.

A first discharge electrode 112 and a second discharge electrode 113 are disposed on an inner surface of the first substrate 111 parallel to an X direction of the plasma display panel 100. The first and second discharge electrodes 112, 113 are respectively disposed in each discharge cell and face each other toward the center line of the discharge cell. The first discharge electrode 112 and the second discharge electrode 113 are alternately disposed along the Y direction of the plasma display panel 100.

A light absorbing layer 116 is disposed on a non-discharge area between a pair of the first discharge electrode 112 and the second discharge electrode 113 and another adjacent pair of the first discharge electrode 112 and the second discharge electrode 113. The light absorbing layer 116 is disposed parallel to the X direction of the plasma display panel 100.

The first discharge electrode 112, the second discharge electrode 113, and the light absorbing layer 116 are buried in a first dielectric layer 114. A passivation film layer 115 such as a MgO film is formed on a surface of the first dielectric layer 114 to protect the first dielectric layer 114 and to increase in the emission of secondary electrons.

Address electrodes 162 are formed on an inner surface of the second substrate 161 in a Y direction of the plasma display panel 100 and in a direction crossing the first discharge electrode 112 and the second discharge electrode 113. The address electrodes 162 are buried in a second dielectric layer 163.

In this way, one sustain discharge electrode pair composed of the first discharge electrode 112 and the second discharge electrode 113 and the address electrode 162 crossing the sustain discharge electrode pair are disposed in each discharge cell. This structure corresponds to a three-electrode surface discharge type plasma display panel, but the structure of the present invention is not limited thereto.

A barrier rib 164 that defines a plurality of discharge cells together with the first substrate 111 and the second substrate 161 are disposed between the first substrate 111 and the second substrate 161. The barrier rib 164 is formed of a dielectric material made of a glass paste in which various fillers are mixed.

The barrier rib 164 includes first barrier ribs 164a disposed in a direction (the X direction of the plasma display panel 100) crossing the address electrodes 162 and second barrier ribs 164b disposed in a direction (the Y direction of the plasma display panel 100) parallel to the address electrodes 162. The second barrier ribs 164b define each of the discharge spaces by extending from an inner wall of the stripe shaped first barrier ribs 164a toward the inner wall of another adjacent stripe shaped first barrier ribs 164a. The combined first and second barrier ribs 164a, 164b form a matrix, and as a result, the discharge cells have a rectangular shape.

Alternately, the barrier rib 164 can be formed in various types such as a meander type, a delta type, or a honeycomb type. Also, the discharge cells defined by the barrier rib 164 can be any shape as long as it can define discharge cells other than the rectangular shape, such as a hexagonal shape, a circle shape, or an oval shape.

A discharge gas such as a Ne—Xe gas or a He—Xe gas is filled in the discharge cells defined by the first substrate 111, the second substrate 161, and the barrier ribs 164.

Phosphor layers 165 of red, green, and blue color are formed in each discharge cell to emit visible light when the phosphor layers 165 are excited by ultraviolet rays generated from the discharge gas. The phosphor layers 165 can be coated in any region of the discharge cell. However, in the current embodiment, the phosphor layers 165 are coated on inner walls of the barrier ribs 164 and on an upper surface of the second dielectric layer 163 to a predetermined thickness.

The red, green, and blue color phosphor layers 165 are respectively coated in each discharge cell. The phosphor layer 165 of red color may be formed of (Y,Gd)BO₃;Eu⁺³, the phosphor layer 165 of green color may be formed of Zn₂SiO₄:Mn²⁺, and the phosphor layer 165 of blue color may be formed of BaMgAl₁₀O₁₇:Eu²⁺.

In the current embodiment, the first discharge electrode 112 and the second discharge electrode 113 respectively have a structure formed by connecting at least two sub-electrodes. Portions of the first discharge electrode 112 and the second discharge electrode 113 disposed in a display area that displays images have different areas from portions of the first discharge electrode 112 and the second discharge electrode 113 disposed in a non-display area, which will now be described in detail.

The first discharge electrode 112 extends along the X direction of the first substrate 111. A plurality of sub-electrodes 112a, 112b, 112c are electrically connected in the first discharge electrode 112. That is, the first discharge electrode 112 includes first through third sub-electrodes 112a, 112b, 112c separated a predetermined distance from each other in an outward direction (the Y direction of the plasma display panel 100) of the discharge cell from the center of each of the discharge cells, and the first through third sub-electrodes 112a, 112b, 112c are parallel to each other.

All of the first through third sub-electrodes 112a, 112b, 112c have a stripe shape, but the present invention is not limited thereto. Also, in the current embodiment, the first discharge electrode 112 has a structure in which three sub-electrodes 112a, 112b, 112c are formed, but the number of the sub-electrodes can be increased or decreased as long as the sub-electrodes are formed in multiple numbers.

The first through third sub-electrodes 112a, 112b, 112c are electrically connected by a plurality of first bridge electrodes 112d. The first bridge electrodes 112d are respectively disposed between the first and second sub-electrodes 112a, 112b and, at the same time, between the second and third sub-electrodes 112b, 112c.

The first bridge electrodes 112d are respectively disposed on a central portion of the discharge cell along the Y direction of the first substrate 111 in each of the discharge cells, and are disposed in an in-line state in a direction crossing the first through third sub-electrodes 112a, 112b, 112c.

The second discharge electrode 113 extends in the X direction of the first substrate 111. The second discharge electrode 113 has substantially the same shape as the first discharge electrode 112, and is symmetrically disposed with respect to the first discharge electrode 112.

The second discharge electrode 113 includes fourth through sixth sub-electrodes 113a, 113b, 113c separated a predetermined distance in an outward direction (the Y direction of the plasma display panel 100) from the center of the discharge cell. The fourth through sixth sub-electrodes 113a, 113b, 113c are parallel to each other and have a stripe shape.

The fourth through sixth sub-electrodes 113a, 113b, 113c are electrically connected by a plurality of second bridge electrodes 113d. The second bridge electrodes 113d are respectively disposed between the fourth and fifth sub-electrodes 113a, 113b and, at the same time, between the fifth and sixth sub-electrodes 113b, 113c.

The second bridge electrodes 113d are disposed in the center of the discharge cells along the Y direction of the first substrate 111, but the present invention is not limited thereto. The second bridge electrodes 113d can be disposed in an in-line state in a direction crossing the first through third sub-electrodes 112a, 112b, 112c.

The first discharge electrode 112 and the second discharge electrode 113 are not formed of a transparent electrode but formed of a metal having high conductivity without indium tin oxide.

The first and second discharge electrodes 112, 113 can be formed in a single layer structure, but may be formed in a multiple layer structure formed of materials substantially having different conductivities from each other. When the first and second discharge electrodes 112, 113 are formed in a multiple layer structure, each of the layers can be formed of conductive materials different from each other.

That is, a first layer directly formed on an inner surface of the first substrate 111 can be a metal oxide layer having black color such as a chrome oxide layer, a second layer formed on a surface of the first layer can be a conductive layer formed of at least a material that has higher conductivity than the first layer and can reduce reflectance of external light selected from the group consisting of Ag, Pt, Ni, Cu, and Pd.

The first and second discharge electrodes 112, 113 can be manufactured by including carbon nanotubes to increase the emission of secondary electrons.

In order to simplify the manufacturing process of the first and second discharge electrodes 112, 113, the first through third sub-electrodes 112a, 112b, 112c, the first bridge electrodes 112d disposed between the first through third sub-electrodes 112a, 112b, 112c, the fourth through sixth sub-electrodes 113a, 113b, 113c, and the second bridge electrodes 113d disposed between the fourth through sixth sub-electrodes 113a, 113b, 113c may be simultaneously formed. The first and second discharge electrodes 112, 113 can be formed to a thick film using a photosensitive paste by printing or to a thin film by sputtering or deposition.

A black stripe shaped light absorbing layers 116 that can increase optical characteristics of the plasma display panel 100 by increasing bright room contrast are disposed in non-display areas between the discharge cells adjacent in the Y direction of the plasma display panel 100. The light absorbing layers 116 extend along the X direction of the plasma display panel 100 and are disposed in the non-display areas corresponding to the first barrier ribs 164a.

The first and second discharge electrodes 112, 113 and the light absorbing layers 116 are buried in the first dielectric layer 114. The first dielectric layer 114 is formed of a material that can prevent electrical connection between the first and second discharge electrodes 112, 113 during discharge, can prevent the first and second discharge electrodes 112, 113 from being damaged by colliding with positive ions or electrons, and can accumulate wall charges by inducing charges.

The widths of portions of the first and second discharge electrodes 112, 113 disposed in the non-display area of the first substrate 111 are respectively equal to or relatively greater than the widths of the first through third sub-electrodes 112a, 112b, 112c and the fourth through sixth sub-electrodes 113a, 113b, 113c.

Also, the first through third sub-electrodes 112a, 112b, 112c are combined to one unit in the non-display area where images are not displayed such that the first through third sub-electrodes 112a, 112b, 112c can be connected to external terminals.

For this purpose, a first terminal bridge electrode 112e is formed by connecting the first through third sub-electrodes 112a, 112b, 112c to one unit. The first terminal bridge electrode 112e may be disposed on a location corresponding to a dummy barrier rib 164c located on outermost of the second barrier ribs 164b.

The first terminal bridge electrode 112e extends in the same direction as the first bridge electrodes 112d, and connects the first through third sub-electrodes 112a, 112b, 112c by disposing in a direction perpendicular to the first through third sub-electrodes 112a, 112b, 112c.

A first terminal electrode 112f protrudes from the first terminal bridge electrode 112e towards the non-display area of the first substrate 111. The first terminal electrode 112f is disposed along the X direction of the first substrate 111, and disposed on an extended line of the third sub-electrode 112c. The first terminal electrode 112f is connected to a signal transmitting unit such as a flexible printed cable.

A second terminal bridge electrode 113e is formed by connecting end portions of the fourth through sixth sub-electrodes 113a, 113b, 113c to one unit. The second terminal bridge electrode 113e is disposed substantially the same direction as the first terminal bridge electrode 112e on an upper end of the dummy barrier rib 164c. The second terminal bridge electrode 113e connects the fourth through sixth sub-electrodes 113a, 113b, 113c by disposing in a direction perpendicular to the fourth through sixth sub-electrodes 113a, 113b, 113c.

A second terminal electrode 113f protrudes from the second terminal bridge electrode 113e in one unit with the second terminal bridge electrode 113e toward the non-display area of the first substrate 111. The second terminal electrode 113f is disposed on an extended line of the sixth sub-electrode 113c.

At this point, because the first terminal bridge electrode 112e and the first terminal electrode 112f connected to the first terminal bridge electrode 112e, and the second terminal bridge electrode 113e and the second terminal electrode 113f connected to the second terminal bridge electrode 113e are disposed on the non-display area of the first substrate 111, the problem of separating the electrodes from the first substrate 111 can occur.

In order to prevent this problem, the widths W1 of the first terminal bridge electrode 112e and the second terminal bridge electrode 113e respectively are formed at least identical to or greater than the widths W2 of the first through third sub-electrodes 112a, 112b, 112c and the fourth through sixth sub-electrodes 113a, 113b, 113c.

Also, the widths W3 of the first terminal electrode 112f and the second terminal electrode 113f respectively are formed at least identical to or greater than the widths W2 of the first through third sub-electrodes 112a, 112b, 112c and the fourth through sixth sub-electrodes 113a, 113b, 113c.

Corner portions of the first terminal bridge electrode 112e and the second terminal bridge electrode 113e facing each other are rounded.

That is, a corner portion R1 of the first terminal bridge electrode 112e extending from the first sub-electrode 112a is rounded to have a predetermined curvature, and a corner portion R2 of the second terminal bridge electrode 113e extending from the fourth sub-electrode 113a is rounded to have a predetermined curvature.

The purpose of the rounding of the corner portions of the first terminal bridge electrode 112e and the second terminal bridge electrode 113e facing each other is to prevent the concentration of a field at the corners portions when a predetermined voltage is applied to the terminal bridge electrodes 112e, 113e.

An operation of the plasma display panel 100 having the above structure according to an embodiment of the present invention will now be described.

When a predetermined voltage is applied between the second discharge electrode 113, which corresponds to the Y electrode, and the address electrodes 162, wall charges are accumulated on the surface of the first dielectric layer 114. In this state, a sustain discharge is generated by applying an alternate current between the first discharge electrode 112, which corresponds to the X electrode, and the second discharge electrode 113.

The sustain discharge between the first discharge electrode 112 and the second discharge electrode 113 will be described in detail. When an alternate current voltage of 180V is applied between the first discharge electrode 112 and the second discharge electrode 113, an initial sustain discharge is generated between the first sub-electrode 112a and the fourth sub-electrode 113a disposed closest to a central region of the discharge cell where the discharge distance is relatively short, and the discharge consecutively expands to the second and third sub-electrodes 112b, 112c and the fifth and sixth sub-electrodes 113b, 113c consecutively disposed outwards of the discharge cell.

In a state that charges are formed in a discharge space due to the initial discharge, a main discharge is generated by an alternate current voltage applied between the first discharge electrode 112 and the second discharge electrode 113. The charges and ultraviolet rays formed during the initial discharge facilitate the generation of the main discharge by accelerating an insulation breakage action of the discharge gas filled between the second and third sub-electrodes 112b, 112c and the fifth and sixth sub-electrodes 113b, 113c consecutively disposed outwards of the discharge cell.

In this way, after the discharge gas is excited by the main discharge generated between the first discharge electrode 112 and the second discharge electrode 113 by an alternate current voltage applied between the first discharge electrode 112 and the second discharge electrode 113, ultraviolet rays are generated from the discharge gas while the energy level of the discharge gas is reduced. The generated ultraviolet rays excite phosphor layers 165 formed at least on a surface of the discharge space defined by the barrier ribs 164 in order to emit visible light, and the emitted visible light displays predetermined numbers, letters, or graphics.

The plasma display panel according to the present invention provides the following advantages.

First, the disconnection of discharge electrodes can be prevented, thereby reducing the discharge electrodes defect rate.

Second, the peeling off of discharge electrodes from a non-display area of a substrate can be prevented.

Third, the concentration of fields can be prevented when a predetermined voltage is applied to the discharge electrodes.

Fourth, because the discharge electrodes are not manufactured simultaneously using a transparent conductive film and a non-transparent metal material, the manufacturing process is simple, which thereby reduces manufacturing costs.

Fifth, initiation of discharge is easy, and optimum brightness can be maintained by controlling the width and thickness of the discharge electrodes.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a first substrate;
a second substrate facing the first substrate; and
a pair of discharge electrodes disposed between the first substrate and the second substrate, the pair of discharge electrodes including a first discharge electrode having a plurality of first discharge sub-electrodes, and a second discharge electrode facing the first discharge electrode and having a plurality of second discharge sub-electrodes,
wherein a width of the first discharge electrode in a non-display area is greater than or equal to a width of the first discharge electrode in a display area, and a width of the second discharge electrode in the non-display area is greater than or equal to a width of the second discharge electrode in the display area.

2. The plasma display panel of claim 1, wherein the plurality of first discharge sub-electrodes are electrically connected to each other, the plurality of second discharge sub-electrodes are electrically connected to each other, and the plurality of first discharge sub-electrodes and the plurality of second discharge sub-electrodes extend in a same direction.

3. The plasma display panel of claim 2, wherein:
the plurality of first discharge sub-electrodes have at least two first discharge sub-electrodes parallel to each other, the at least two first discharge sub-electrodes being connected by first bridge electrodes disposed therebetween, and
the plurality of second discharge sub-electrodes have at least two second discharge sub-electrodes parallel to each other, the at least two second discharge sub-electrodes being connected by second bridge electrodes disposed therebetween.

4. The plasma display panel of claim 3, wherein the plurality of first discharge sub-electrodes and the plurality of second discharge sub-electrodes have a stripe shape.

5. The plasma display panel of claim 2, wherein:
a first terminal bridge electrode is formed by connecting end portions of the plurality of first discharge sub-electrodes, and
a second terminal bridge electrode is formed by connecting end portions of the plurality of second discharge sub-electrodes.

6. The plasma display panel of claim 5, wherein widths of the first terminal bridge electrode and the second terminal bridge electrode are greater than or equal to widths of the plurality of first discharge sub-electrodes and the plurality of second discharge sub-electrodes disposed in the display area.

7. The plasma display panel of claim 5, wherein:
a first terminal electrode protrudes from the first terminal bridge electrode in a same direction as the plurality of first discharge sub-electrodes, and
a second terminal electrode protrudes from the second terminal bridge electrode in a same direction as the plurality of second discharge sub-electrodes.

8. The plasma display panel of claim 7, wherein:
the first terminal electrode extends from one of the plurality of first discharge sub-electrodes disposed outermost from a center of a discharge cell, and
the second terminal electrode extends from one of the plurality of second discharge sub-electrodes disposed outermost from the center of a discharge cell.

9. The plasma display panel of claim 1, wherein widths of the first terminal electrode and the second terminal electrode are greater than or equal to widths of the plurality of first discharge sub-electrodes and the plurality of second discharge sub-electrodes disposed in the display area.

10. The plasma display panel of claim 5, wherein portions of the first terminal bridge electrode and the second terminal bridge electrode facing each other are rounded.

11. The plasma display panel of claim 2, wherein the first discharge electrode and the second discharge electrode face each other and are symmetrical to each other in a discharge cell.

12. The plasma display panel of claim 1, wherein the first discharge electrode and the second discharge electrode are formed of carbon nanotubes.

13. The plasma display panel of claim 1, wherein the first discharge electrode and the second discharge electrode are formed of a metal having high conductivity.

14. The plasma display panel of claim 1, wherein light absorbing layers are disposed parallel to and on both sides of the pair of discharge electrodes.

15. The plasma display panel of claim 1, further comprising:
address electrodes crossing the first discharge electrode and the second discharge electrode, the address electrodes generating an address discharge, the first discharge electrode and the second discharge electrode generating a sustain discharge.

16. The plasma display panel of claim 1, further comprising:
a barrier rib disposed between the first substrate and the second substrate;
a first terminal bridge electrode formed by connecting end portions of the plurality of first discharge sub-electrodes, and
a second terminal bridge electrode formed by connecting end portions of the second discharge sub-electrodes, wherein
the first terminal bridge electrode and the second terminal bridge electrode are disposed on a location corresponding to a dummy barrier rib, the dummy barrier rib corresponding to an outermost area of the barrier rib.
